(19) United States
(12) Patent Application Publication
(10) Pub. No.: US 2017/0287011 A1
(43) Pub. Date: Oct. 5, 2017

(54) System and method for displaying content on disposable packaging

(71) Applicant: International Culinary ChefsBest, LLC, San Diego, CA (US)

(72) Inventor: Lisa Liguori, San Diego, CA (US)

(21) Appl. No.: 15/479,998

(22) Filed: Apr. 5, 2017

Related U.S. Application Data
(60) Provisional application No. 62/318,340, filed on Apr. 5, 2016.

(51) Int. Cl. G06Q 30/02; H04B 5/00

(52) U.S. Cl. CPC G06Q 30/0267; H04B 5/0037; H04B 5/0031

(57) ABSTRACT

A system and method for displaying content on disposable packaging includes a display board, such as a light emitting diode display board, embedded within or on the product package. While the product package will include various electronic components, the packaging itself is without an integrated power source sufficient to provide power throughout the life of the product package. Rather, an external power source is provided in close proximity to the packaging to provide electrical power. The package's electronic components include components for wireless communication with nearby electronic devices, such as mobile phones. The nearby electronic devices will provide data to the package to cause the display board to display content dynamically to nearby users. The content displayed may be dependent upon the type of product, data about the user, and third party consumer data.

### CROSS REFERENCE TO RELATED APPLICATIONS

This document claims the benefit of U.S. Prov. Pat. App. No. 62/318,340 filed on Apr. 5, 2016, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general fields of product packaging and networked systems, and more specifically toward a system and method for displaying content on disposable packaging. Disposable packaging includes a display board, such as a light emitting diode display board, embedded within or on the product package. While the product package will include various electronic components, the packaging itself is without an integrated power source sufficient to provide power throughout the life of the product package. Rather, an external power source is provided in close proximity to the product package to provide electrical power. The package's electronic components include components for wireless communication with nearby electronic devices, such as mobile phones. The nearby electronic devices will provide data to the package to cause the display board to display content dynamically to nearby users. The content displayed may be dependent upon the type of product, data about the user, and third party consumer data.

More and more consumers research their purchases using a mobile device, many times while at the store itself. From customer reviews to ingredient lists to complementary products, consumers use mobile devices to help guide which products to purchase. By tracking products purchased by individual consumers, customized ratings and buying guides may be generated. In fact, many consumers are beginning to expect product information and advertising that are customized to their preferences and buying habits.

On crowded store shelves, products compete for space as well as the attention of consumers. Bright product packaging, well-known brand names, prime store shelf real estate, and display cases are some of the ways products are highlighted to passing consumers. The product's package itself also has limited space on which to place product information and promotional material. Thus, there is limited physical space in which to display product information, brand names, and other data to inform and entice consumers to purchase a particular product.

Thus, there has existed a long-felt need for a system and method for displaying dynamic and customized messages on disposable packaging according to which individuals are close to the products, and the preferences of those individuals.

### SUMMARY OF THE INVENTION

The current invention provides just such a solution by having a system and method for displaying content on disposable packaging. Disposable packaging includes a display board, such as a light emitting diode display board, embedded within or on the product packaging. While the product packaging will include various electronic components, the packaging itself is without an integrated power source sufficient to provide power throughout the life of the product packaging. Rather, an external power source is provided in close proximity to the packaging to provide electrical power. The package's electronic components include components for wireless communication with nearby electronic devices, such as mobile phones. The nearby electronic devices will provide data to the package to cause the display board to display content dynamically to nearby users. The content displayed may be dependent upon the type of product, data about the user, and third party consumer data.

Product packaging that changes based upon who is in view of, or at least close to, the packaging can have significant benefits. A particular product may have several selling points, but choosing which selling point or points to highlight on the product packaging can be difficult, as different consumers will value different product attributes. By changing what is displayed on the product packaging, relevant product messages are displayed to individuals that may be viewing that particular product. Marketers no longer need to choose a particular product message or information over others; rather, product messaging can change. In fact, the product packaging can be changed after the product hits the store shelf. Recently received awards can be highlighted in packaging. Product sales can be updated to further promote best sellers. Dynamic and customized product packaging greatly increases the options for marketing products to groups and individuals.

The display part of the product package is just one component of the system, which requires electrical power to operate. Providing electrical power to the product package from an external source allows for a long shelf life for the display board, especially compared to using batteries. Furthermore, batteries can be expensive, which can result in a cost prohibitive system for many products. Powering the electronic components through contactless inductive power allows for more flexible product arrangement on shelves, thereby reducing “contact” error's when stocking store shelves, as well as increasing the speed at which store shelves can be restocked with the product.

In addition to electrical power, the display board requires data to produce the desired content on the product package. Instead of having the product packaging communicate directly with a remote server system, the product packaging communicates only with nearby mobile devices. Retailers need not provide potentially costly network access to hundreds or thousands of products. Instead, the products communicate with mobile devices which in turn communicate with remote server systems, if available. This allows for the aggregation of multiple requests from products into a single request from a mobile device. Additionally, should there be no network access by the mobile device to the remote server system, the mobile device may nonetheless provide data to the product packages using offline data that has previously been generated and/or stored on the mobile device.

It is an object of the current disclosure to provide a system for displaying customized content on product packaging based upon which individuals are in close proximity to the product.

It is another object of the current disclosure to provide a method for displaying dynamic messages on product packaging.

It is a further object of the current disclosure to provide a system and method for dynamically changing product packaging with recent and relevant product information using nearby mobile devices.

A particular embodiment of the current disclosure is a system for displaying content on product packaging comprising a product package, where the product package comprises a display board, a wireless communications interface, and a power transfer adapter; and a mobile device, where the mobile device comprises a wireless communications interface; where the mobile device and product package communicate via their respective wireless communications interfaces, and where the display board of the product package displays content indicated by data provided by the mobile device through the wireless communications interfaces. The mobile device further comprises a processor executing programming logic for interfacing with the product package; the programming logic configured to: receive identity data from the product package; determine whether there is valid content available for the product package; and send an update display request to the product package, where the update display request comprises data indicating the content to display on the display board of the product package. The data indicating the content to display on the display board of the product package comprises graphic data, text data, or both. The programming logic is further configured to request the identity data of the product package. The display board of the product package comprises a liquid crystal display. The power transfer adapter is a wireless power transfer adapter, where the wireless power transfer adapter comprises coiled wires that generate electrical current from incident magnetic fields. The system further comprises a remote server system, where the remote server system comprises a processor executing programming logic for interfacing with the mobile device; the programming logic configured to receive a product data request from the mobile device, where the product data request comprises a product identifier; obtain product data using the product identifier; determine appropriate content to display on the product packaging; and send response data to the mobile phone, where the response data comprises data indicating the content to be displayed on the product package, where the remote server system and mobile device communicate over a wide area network. The data indicating the content to be displayed on the product package of the response data comprises graphic data, text data, or both.

Another embodiment of the current disclosure is a method for displaying content on product packaging comprising the steps of: receiving identity data from a product package; sending the identity data to a remote server system; receiving response data from the remote server system; and sending content data to the product package; where the product package comprises a display board, whereby the content data sent to the product package is used to display content on the display board of the product package. The method further comprises the step of requesting the identity data of the product package prior to receiving identity data from the product package. The method further comprises the step of determining if valid content is available for the product package. The product package further comprises electronic memory, wherein the content data comprises a reference to content previously stored in the electronic memory of the product package. The method further comprises the step of sending user data to the remote server. The user data comprises data indicating products in a corresponding user's shopping cart. The user data comprises data indicating a user's preferences. The response data from the server system comprises a value of matching criteria.

Yet another embodiment of the current disclosure is a method for displaying content on a product package, where the product package comprises a display board and a wireless communications interface, the method comprising the steps of: sending identity data to a mobile device; receiving a display update request from the mobile device; determining the content to use for the display board using the display update request received from the mobile device; and displaying the content on the display board. The product packaging further comprises electronic memory, where the electronic memory stores a plurality of display elements, wherein the display update request received from the mobile device comprises a reference to one of the plurality of display elements stored in the electronic memory. The method further comprises the steps of: storing a plurality of display update requests; and waiting a period of time; wherein the step of determining the content to use for the display board using the display update request received from the mobile device comprises selecting one of the plurality of display update requests. The step of selecting one of the plurality of display update requests uses a value of matching criteria.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

As used herein, the term “content” includes text, images, graphics, or other visual depictions of material that may be displayed on product packaging; the term “product packaging,” “product package,” or “disposable packaging” refers to a covering wrapper or container for a product that is intended to be discarded after purchase of the product; and the term “mobile device” refers to interactive portable electronic devices such as mobile phones, tablets computers, watches, and glasses.

There has thus been outlined, rather broadly, the more important features of the invention in order that the detailed description thereof may be better understood, and in order that the present contribution to the art may be better appreciated. There are additional features of the invention that will be described hereinafter and which will also form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a side view of a product package according to selected embodiments of the current disclosure.

FIG. 2 is a flow chart showing the product package operation for identity requests from mobile devices according to selected embodiments of the current disclosure.

FIG. 3 is a flow chart showing the product package operation for display update requests from mobile devices according to selected embodiments of the current disclosure.

FIG. 4 is a flow chart showing the mobile device operation for requesting a display update of product packaging according to selected embodiments of the current disclosure.

FIG. 5 is a flow chart showing the server system operation for processing a product data request according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

Disposable packaging includes a display board, such as a light emitting diode display board, embedded within or on the product packaging. The main body of disposable packaging is often made from paper products such as cardboard. According to selected embodiments of the current disclosure, a display board, sometimes referred to simply as a display, is affixed to the main body of the product packaging. Adhesives, tape, or other similar materials may be used to attach the display board to the main body.

The display board itself includes multiple components to display content on the product packaging. This content can change from time to time based on various factors, discussed in more detail herein. In selected embodiments, the display board comprises a liquid crystal display (LCD). A liquid-crystal display is a flat-panel display or other electronic visual display that uses the light-modulating properties of liquid crystals. Depending upon the particular product and desired criteria for the display, such as cost and power requirements, the LCD may employ a passive matrix or an active matrix, and may be lit or unlit. Furthermore, the resolution, size, and shape of the LCD may be designed to fit the requirement of the particular product packaging. For example, a small, square LCD in the corner of the front of product packaging may be sufficient to display various certification and informational marks for an inexpensive product. On the other hand, an irregularly shaped LCD may cover a larger portion of the surface of the packaging for a high-end product, able to transform the overall look and feel of the product packaging.

In addition to the display board, other electrical components are integrated into the product packaging. Wireless communication components are connected, directly or indirectly via other electrical components, to the display board. The wireless communication components enable the product packaging to transfer and/or receive data from other devices. Particular embodiments of the current disclosure provide for wireless communication components that implement near field communication (NEC) protocols, radio-frequency identification (REED), Bluetooth (including Bluetooth LE), IEEE 802.11 protocols, and other wireless communication protocols and standards for transmitting and receiving data over relatively small distances. Memory, data processors, and other electronic components are incorporated according to selected embodiments of the current disclosure, to process, store, and manage data and the other electronic components of the product packaging system.

Electrical power is required to operate the display board, wireless communication, and other electrical components of the product packaging. Particular embodiments of the current disclosure provide for using wireless power transfer, such as electromagnetic induction, to transfer electrical power to the electrical components of the product packaging. Electrical power is transferred over short distances by magnetic fields using inductive coupling between coils of wire or by electric fields using capacitive coupling between electrodes. By way of example, a magnetic field may be generated by components on or integrated into a store shelf. The bottom of the product packaging includes the coiled wires that generate electrical current from the incident magnetic fields. As will be appreciated by those skilled in the art, placement of the coiled wires is important to generating sufficient electrical power. While the placement of the display board should be in a place that is highly visible, the inductive power components, or wireless power transfer adapter, are placed closer towards the bottom, if not on the bottom, of the product packaging. This may necessitate wiring across portions of the product packaging.

Additional electrical components may be added to regulate the power generated from the wireless power transfer. Each product package may encounter different magnetic fields, thereby resulting in different levels of electrical power that is generated. Power conditioning components may therefore be integrated to correct and provide the appropriate voltage required by the other electronic components.

Furthermore, selected embodiments include capacitors or batteries to store and dispense power when power from external sources is unavailable. For example, the product may be removed from the store shelf by a potential consumer, thereby taking it out of range of the wireless power transfer. In such an instance, the capacitors and/or batteries provide electrical power for a brief period of time, thereby enabling the message board of the product packaging to continue to operate. This provides additional display time for the message board until the product is either returned to the store shelf, or the consumer decides to purchase the product.

While the product packaging may include small, inexpensive batteries or capacitors, the packaging itself is without a long term integrated power source. Large, powerful batteries and solar panels can be used to power the product packaging, but they are expensive and/or have a limited time frame of providing power. Furthermore, batteries and solar panels are relatively expensive. Thus, by relying on an external power source, the overall cost of the product packaging is reduced.

Instead of using wireless power transfer, electrical contacts may be provided on both the store shelving and product packaging. The electrical contacts of the product packaging are the power transfer adapter, which takes the place of the wireless power transfer adapter. While this is a more efficient transfer of electrical power to the product packaging compared to wireless power transfer, it relies upon physical contact for both positive and negative terminals. This necessitates proper product placement on store shelves. Tracks or asymmetrical product packaging and shelf space can assist in aligning the electrical connections. Furthermore, physical electrical contacts require precise product dimensions, as variations in the surface of the product packaging may result in the electrical contacts being some distance apart.

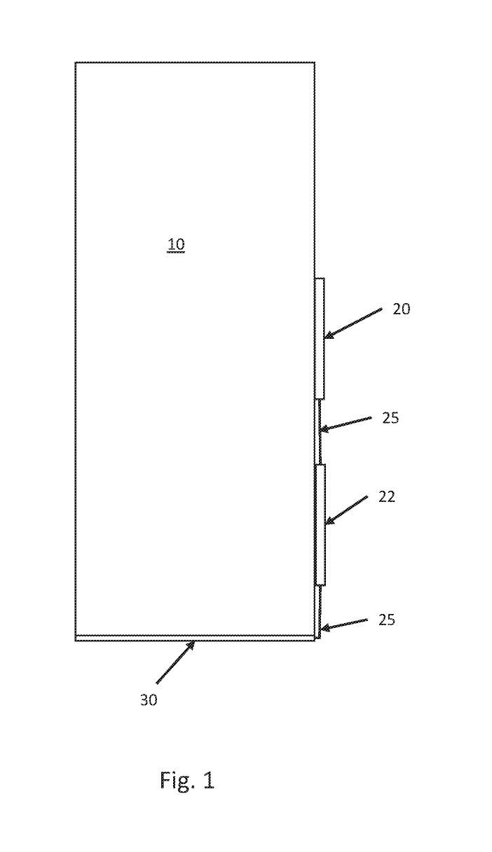

FIG. 1 is a side view of a product package according to selected embodiments of the current disclosure. A product package 10 includes a power adapter 30 located at the bottom of the product package. The power adapter 30 is electrically connected to circuitry 22 and a display board 20 via wiring 25. The power adapter 30 provides power to the display board via a wireless source, such as through electromagnetic induction, or through physical contacts with an external power source, as discussed above. Circuitry 22 may include a wireless communications interface, such as hardware and/or software for communicating via RFID, Bluetooth, WiFi, or other comparable protocols. Circuitry 22 may also include processors, memory, and display drivers to process data, store content, and cause the display board to display particular content.

The display board can display various images, figures, data, text, or other visual imagery to consumers viewing the product packaging. Data to generate the content on the display board is obtained through the wireless communication components. More specifically, the data is transmitted by another electronic device, such as a mobile device, in close proximity to the product packaging that also includes a wireless communications interface. As will be appreciated, multiple mobile devices may interact with a single product package, and multiple product packages may interact with a single mobile device.

In a particular embodiment, a mobile device in relatively close proximity to multiple product packages provides data to generate the same content on the product packages. RFID communication may be used to send out the same content to all RFID tags of the same type. Data can be stored, and used to generate an image, text, or other content. The content may be previously stored in electronic memory of the product packaging, whereby the data that is received is used to select the appropriate content. The electronic memory may be read only member (ROM) that is programmed once and is fixed throughout the life of the packaging, or writeable memory that stores and overwrites content. Alternatively, the data to generate the content itself may be transmitted from a mobile device.

The product packaging display system, according to selected embodiments of the current disclosure, includes a product package with a dynamic display board, and a mobile device. The mobile device wirelessly communicates with the packaging. When the mobile device is sufficiently close enough to the packaging to begin communication, the packaging sends and the mobile device receives data about that particular product package. This can include a product identifier, product name, ingredients, product attributes, and other relevant data. The mobile device processes the data and, if connected to the Internet, obtains additional content based upon the data provided by the product packaging. The mobile device then sends, and the packaging receives data from the mobile device. This data is sufficient to cause the packaging to display a particular message, image, or other visual depiction on the display board of the packaging.

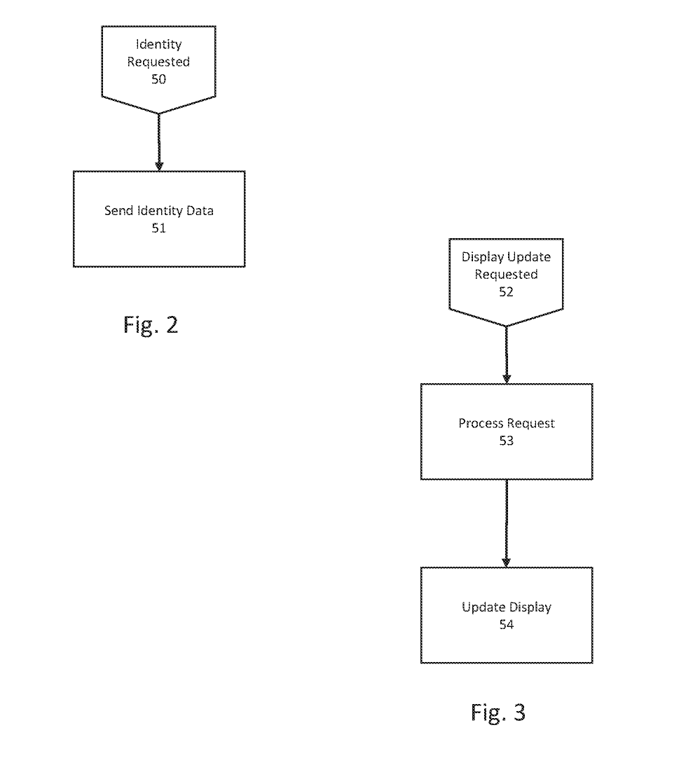

FIG. 2 is a flow chart showing the product packaging operation for identity requests from mobile devices according to selected embodiments of the current disclosure. The product packaging receives an identity request 50 from a mobile device. In response, the packaging sends identity data 51 about the product back to the mobile device. In certain embodiments, the identity data is merely a product identifier that uniquely identifies the product or type of product in the packaging. In other embodiments, a product identifier along with other data is provided, where the other data may include data about the type of product or about that particular product. For example, identity data may include ingredients, components, shelf life, use by or best by date, location of manufacture, allergy information, size, weight, nutritional information, certifications, and awards. Furthermore, the identity data may also include data used to send display update requests back to the product packaging, such as display configurations and protocols.

FIG. 3 is a flow chart showing the product packaging operation for display update requests from mobile devices according to selected embodiments of the current disclosure. The product packaging receives a display update request 52 from a mobile device. The packaging processes that request 53 to determine what content should be used to update the display, and then updates the display 54. When the mobile device sends a request to update the display 52, it sends data that may include only a reference to additional data already stored within the memory of the product packaging. For example, the product packaging may include eight different image files stored within its memory. The data sent by the mobile device references one of those eight images. Thus, when processing the request, the product packaging determines which of the eight images should be displayed, recalls that image data from its electronic memory, and updates the display board to show that image. In an alternative embodiment, the mobile device may send data sufficient to display content on the display board without recalling previously stored data within the memory of the packaging. For example, the mobile device may send textual data with the request to update the display. The packaging processes the request, and causes the text sent with the request from the mobile device to be shown on the display. As another example, the mobile device may send image data, such as JPEG formatted image data. This data is received and processed by the product packaging and shown on its display.

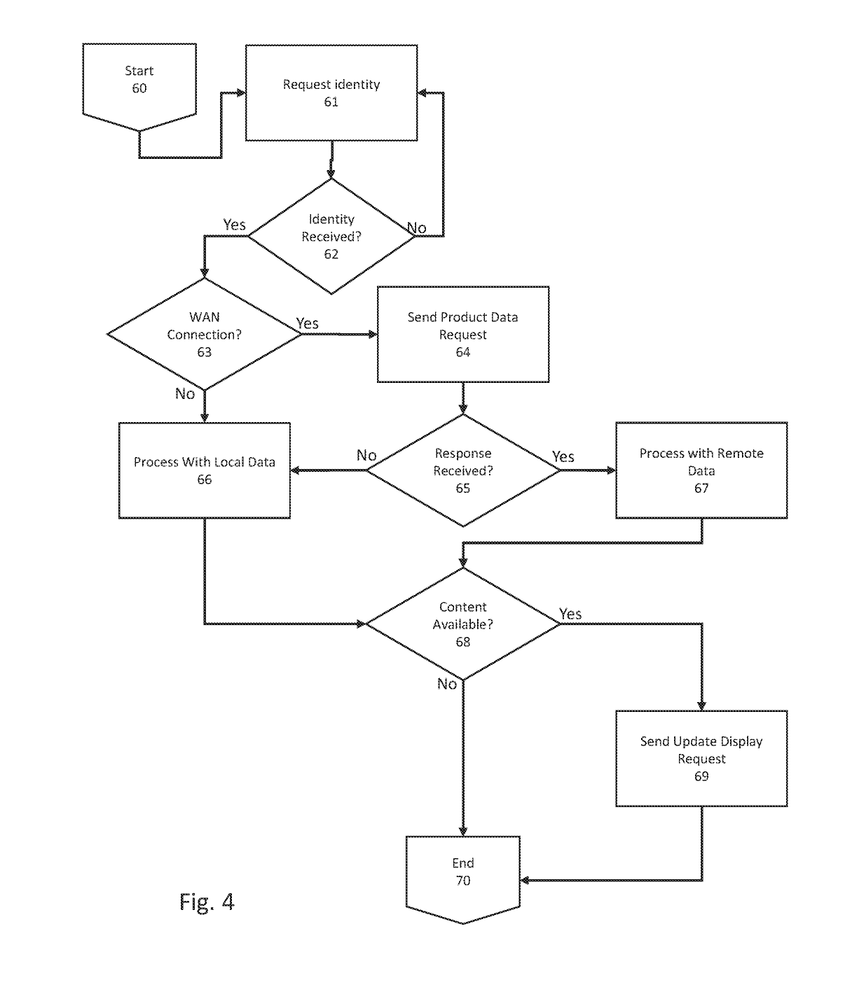

FIG. 4 is a flow chart showing the mobile device operation for requesting a display update of product packaging according to selected embodiments of the current disclosure. To start, the mobile device requests the identity 61 of nearby products. The mobile device then determines if a response has been received 62. If no products respond with identifying information, the mobile device once again requests identities 61 from nearby products. This process may be implemented in various ways. One embodiment provides for a pairing type request such that the two devices may pair up to communicate, and once communication is established, an identity is sent and received. Another embodiment provides for passive requests and responses. A signal is transmitted by the mobile device, and in response to that signal, the packaging sends out its own signal that includes its identity data, where each signal is sent asynchronously. In yet another embodiment, the packaging broadcasts its identity thereby alleviating the necessity of a request by the mobile device.

Upon receiving identity data from packaging, the mobile device determines whether it has an available wide area network (WAN) connection 63, for example, an internet connection, such that it may communicate with remote servers. If there is an available WAN connection, the mobile device sends a request for product data 64 to a remote server. In a particular embodiment, the request for product data 64 includes identity data, either all or a portion. In another embodiment, the request for product data includes identity data, either all or a portion, along with data that identifies or is associated with the user of the mobile device and/or the mobile device itself. Discussed in more detail below, the remote server system uses the data in the request from the mobile device to determine the most appropriate content to display on the product packaging, and sends a response with corresponding data. If a response is received by the mobile device, the mobile device continues the process with the remote data 67 received from the remote server system.

Using data received from the remote server system to update product packaging allows for a wider range of content to be displayed, more updated content or selection of content, or more personalized content to the user or users proximate to the product packaging. Nonetheless, for a variety of reasons, obtaining remote data from a remote server system may not be possible in all circumstances. For example, there may be no available WAN connection 63, and thus the mobile device must continue the process with local data 66. Additionally, even if there is a WAN connection 63, the remote server system may be unavailable or otherwise cannot return a valid response 65. In such an instance, the mobile device should also continue to process with local data 66.

Whether or not the mobile device has received data from a remote server system, or is continuing with data it already has locally, the mobile device determines whether it has valid content available 68, or sufficient data to produce said content, to send to the product packaging.

Valid response data received from the remote server system includes data sufficient to determine whether or not content is available 68 for that particular packaging. In a particular embodiment, the remote server system is able to determine from the identity of the product and the identity of the user what content should be displayed on the product packaging. This content is provided in the response to the mobile device. The mobile device then need only verify that it has received the valid content. While unlikely, the remote server system may determine that no content should be displayed for the product packaging for the particular mobile device, and therefore the mobile device will determine from the response that no content is available.

In another embodiment, the remote data received from the remote server system does not include the content to display itself, but rather a reference to content already stored on the local memory of the mobile device. Likewise, the remote data may include a reference to content already stored on the local memory of the product packaging.

Furthermore, the remote server system may send data that has information about the product, but the data does not include specific content or references to specific content that should be displayed. The mobile device must then use the data returned by the remote server system, along with data and preferences stored locally, to determine what content should be displayed. For example, the identity data sent to the remote server indicates that the product is a type of cracker. The remote server system returns data to the mobile device indicating that the crackers are gluten free, peanut and nut free, Kosher, and suitable for vegetarians. The user of the mobile device has set a preference that the user is gluten intolerant. Furthermore, content is available either on the mobile device or on the product packaging to indicate that the product is gluten free. Thus, the mobile device determines that content indicating the product is gluten free should be displayed.

Without a response from the remote server system or if no WAN connection is available, the mobile device may nonetheless continue the process with local data 66 to determine that there is content available 68 to display on the product packaging. When the mobile device receives the identity data from the product packaging, the identity data may include specific information about the product. This information on the product can be used to determine if there is content available to display. For example, the identity data sent from the product packaging indicates that the product is gluten free, peanut and nut free, Kosher, and suitable for vegetarians. The user of the mobile device has set a preference that the user is vegetarian. Furthermore, content is available either on the mobile device or on the product packaging to indicate that the product is suitable for vegetarians.

If the mobile device determines there is content available 68 to update the product packaging, the mobile device sends an update display request 69 to product packaging. The update display request includes data sufficient to produce the specified content on the product packaging. This can either be the content itself, such as graphic or text data, or a reference to data already stored in the local memory of the product packaging. Once the request has been sent, the process ends. Alternatively, if there is no content available to display on the product packaging, the process ends 70.

As will be appreciated by those skilled in the art, after the process ends 70, the process may once again start 60. In fact, a particular process as described in FIG. 4 may start before another similar process has ended. in this manner, multiple processes may process in parallel. The mobile device may also include further systems, instructions, hardware, software, and/or firmware, that manages these processes, whereby additional identity data received for the same type of product are ignored or paused until the prior process has completed, while identity data. received for different products are processed in parallel.

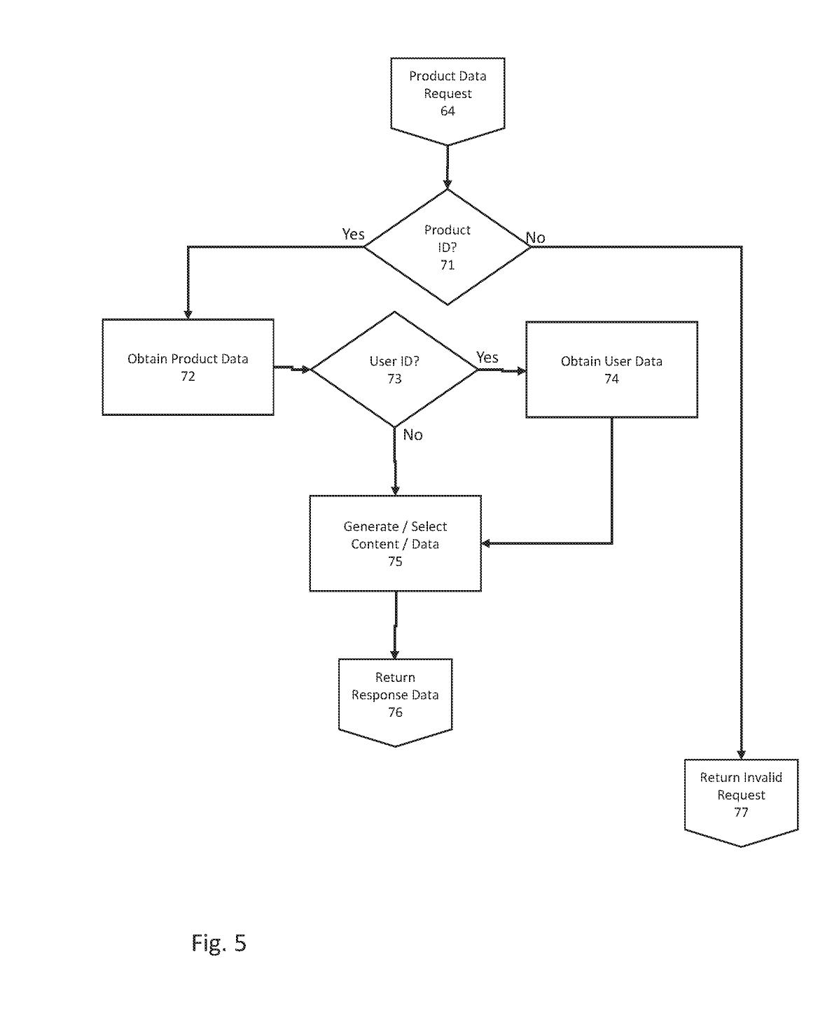

FIG. 5 is a flow chart showing the server system operation for processing a product data request according to selected embodiments of the current disclosure. The server system receives a product data request 64 from a mobile device and determines if a valid product identifier has been provided 71. If no product identifier has been provided 71, then the server system simply returns an invalid request response 77 to the mobile device, lithe server system determines that the product identifier is valid, it obtains product data 72. This can be done by querying a database, other remote systems, file directories, or other searchable data storage systems. After obtaining product data, or in alternative embodiments, while obtaining product data, the server system determines whether a user identifier has been provided 73. If there is a user identifier, the server system obtains user data 74 based upon the user identifier provided. Whether or not user data is obtained, the server system proceeds to generate and/or select content and/or data 75 based upon the product data and, if applicable, user data previously obtained. This step is where the server system determines what is the best or most appropriate content to display on the product packaging, discussed in more detail below. Once the appropriate content or data has been generated or selected 75, response data is generated and returned (or sent) 76 to the mobile device.

The server system uses product data and, if applicable, user data, to determine the most appropriate content to display on the product packaging. If product data is available without any user data, the system can select attributes of the product to promote, such as awards, certifications, important ingredients or nutritional information. The selection of which attribute to display on the packaging can be done on a random, round robin, or using non-personally identifiable criteria, such as marketing research and general consumer trends. If user data is available in addition to the product data, more refined, directed, and relevant content can be selected and displayed on the product packaging. Awards, certificates, ingredients, nutritional information, or other attributes that correspond to positive (or even negative) preferences of a user are selected (or avoided) over other attributes of the product. In this manner, directed and customized content for product packaging is selected, and then ultimately delivered to a user on product packaging.

Particular embodiments of the current disclosure provide for identity requests (and responses) between the product packaging and mobile device using a first protocol, while the specification and/or delivery of content from the mobile device to the product packaging occur using a second protocol. For example, the product packaging and mobile device may first communicate using RFID technology to transfer product identity information from the product packaging to the mobile device. With the product identity information, the product packaging may also provide network information for further communication, such as which protocol to use, network identification, passcodes, authentication tokens, and/or other relevant network data.

In certain environments, multiple mobile devices may interact with a single product. Communication protocols that allow for many to one communication, at least initially, is required to enable the product packaging to communicate its product identifier to multiple mobile devices, potentially simultaneously. It must then, in parallel or serially, receive content data from the mobile devices and determine what content to display. When multiple mobile devices provide content that conflicts, that is, content that cannot simultaneously be displayed or is otherwise mutually exclusive, the product packaging must select one content element to display from the available options. An embodiment of the current disclosure provides for selecting the content that is valid for the most users. In other embodiments, metadata may be provided with the content data from the mobile device (which, in turn may have received it from the server system), that aids in the selection process. This metadata can include the relative relevance of the content for the specific user, a relative value of each content, or other factors. In yet other embodiments, the product packaging selects the first, last, or randomly from the available content options provided by the mobile devices.

To avoid switching between content rapidly, thereby reducing its effectiveness, and to conserve resources, the display board of the product packaging may only refresh at set intervals, such as every ten seconds or thirty seconds. Thus, even if other mobile devices are proximate to the product packaging, the display will not update until after the set period of time expires.

Furthermore, certain environments will encounter multiple products, either of the same or different type, interacting with a single device. In such a scenario, the mobile device may, in parallel or in serial, provide content to the multiple product packages causing their displays to update. Depending on the configuration of the system, each packaging of the same type may display the same or different content. The mobile device may also aggregate multiple product identifiers into a single request to the remote server system. This conserves resources by requiting only a single request to a remote server system to update the content of multiple product packages.

As will be appreciated by those skilled in the art and after reading this disclosure, multiple product packages in close proximity may communicate with multiple mobile devices also in close proximity. Such environments may incorporate a combination of the aforementioned embodiments, whereby a single device communicates with multiple product packages, and each product package communicates with multiple devices and selects the appropriate content to display.

Embodiments of the system disclosed herein may also determine whether particular products have been placed in a user's cart. As discussed above, the product packaging may include sufficient capacitive power to continue to operate after being removed from the shelf. When a user places a product in his or her cart, the product will continue to interact with the mobile device. However, as the user travels through the store, the mobile device will interact with different products, but still interact with the product in the cart. This change in identified products may be used to indicate which products have been placed in the user's cart. Additionally, or alternatively, the mobile device may determine that a product is within a user's cart if it continues to interact with the same product while discontinuing interactions with other products of the same type. Once the mobile device determines that a product has been placed in the user's cart, it can provide this data when making requests to the remote server system.

Data indicating which products the user has placed in his or her cart is transmitted and used by the remote system in particular embodiments of the current disclosure. The mobile device, when making a product data request, will also send user identifying data that contains a list of products determined to be in the user's cart. The remote server system will use the product data and user's preferences, and products in the user's cart to determine the most appropriate content to display on the product packaging.

In an exemplary embodiment, a user of the system has a mobile device. On the mobile device, the user has set a preference that she is interested in award winning foods as judged by professional chefs. The user enters a market, and begins walking down the aisles searching for products to buy. As the user approaches a particular brand of pasta, the product packages of that pasta send their product identities to her mobile device. The mobile device receives this data, and then sends that data, along with the user's preferences, to a remote server system. The remote server system obtains details on the product using the product identity data, where the details include data referencing an award for best taste by professional judges. The server system, knowing that the user prefers award winning products, and this product is award winning, returns content data to the mobile device that includes an image of the award won by that product. The mobile device then sends the data to the product packaging, The product packaging receives the display content from the mobile device, and determining that the image can be displayed on the product packaging, displays that content on its display board. The user, as she walks past the product, views on the product packaging itself that it is an award winning product for best taste, as judged by professional judges.

Continuing with the example, a second user has a mobile device, and has set a preference that he is interested in certified organic foods. Travelling behind the first user by about a minute, the second user approaches the particular brand of pasta, which sends its product identity to his mobile device. As before, the product identity is sent to the server along with user data, the server obtains additional data and determines that an image signifying the product is certified organic is most appropriate, and sends that corresponding data back to the mobile device. The mobile device in turn sends the content to the product packaging, which is then displayed on the packaging.

In another exemplary embodiment, a particular user has a peanut allergy, and has set a preference on her mobile device signifying such an allergy. She is looking for a baking mix, and proceeds down the aisle with baking mixes. As her mobile device comes within communication range of a particular brand of making mix, the product packaging sends its identity data, which includes allergy data, to the user's mobile device. The mobile device does not have an available internet connection. However, the mobile device is able to determine from the identity data provided by the product packaging that this particular brand of baking mix is peanut free and safe for those with peanut allergies. The mobile device then sends content to the product packaging that includes the text “Peanut Free.” The product packaging, upon receiving this content, display's the text “Peanut Free.” The user notices this important dynamic information on the product packaging, and picks up the product to review its contents in more detail.

In yet another exemplary embodiment, a user has a preference set in a remote server system to prefer sugar free products, Travelling down the soda aisle, a sugar free soda product sends its identity data to the mobile device. The device sends that data, along with the user's identifier, to the remote server system. The remote server system Obtains the user's preferences using the provided user identifier, and determines that display content signifying sugar free is appropriate. The remote server system further determines that this content is already stored in the product packaging, and therefore returns content data that includes a content identifier back to the mobile device. The mobile device in turn sends the content identifier to the product packaging, which then recalls the stored data and displays content on the product packaging signifying that it is sugar free.

In a further exemplary embodiment, a user's mobile device communicates with a particular product packaging, such as that for cheese, and the user proceeds to place the product in her shopping cart. As she continues to travel through the store, the mobile device continues to receive the same product's identity data, even though the mobile device detects that the user is moving about the store. Given this data, the mobile device determines that the user is intending to purchase the cheese product. Continuing through the store, the user encounters a complementary product, such as crackers. The mobile device receives identity data from the cracker's packaging, which is transmitted to the remote server system, along with user data that includes a reference to the cheese product already in the user's cart. Using this data, the server system determines that content signifying the crackers as a complementary product to the cheese should be displayed. This data is then in turn sent to the product packaging. As the user approaches, the product packaging displays a message stating “Goes great with cheese!” Seeing this message, and realizing that she has already placed cheese in her cart, the user decides to purchase the crackers as well.

As discussed above, embodiments of the current disclosure provide for product packages that determine the appropriate content to display when they encounter multiple, conflicting content elements to display. For example, two separate users may be in proximity to the same group of cracker products. One user has a strong preference for certified organic products. The second user prefers gluten-free products, and has a gluten free spinach and artichoke dip in her cart. The group of cracker products are both organic and gluten free. The remote server system determines that the cracker product should display that it is certified organic, and that it meets one preference criteria for the first user. The remote server system also determines that the cracker product should display that it is gluten free, and that it meets two preference criteria for the first user. The respective response data (including the number of matching criteria) is sent to the mobile devices, which then send the available content to display (which includes the number of matching criteria) to the product packages. In one embodiment, each cracker product packaging selects the content with the highest number of met criteria, in which case all cracker product packaging displays that the crackers are gluten free. In another embodiment, each cracker product packaging randomly selects between the available content items, such that some cracker product packaging displays that the crackers are gluten free while other product packaging displays that the crackers are certified organic. Since it is unlikely that each product package would receive display content simultaneously from each mobile device, it is contemplated that during each refresh period (for example every ten seconds), all update display requests will be queued or cached and selected from that group of display requests.

In addition, or in the alternative, to providing the number of matching criteria, an overall score for each content element may be computed by the remote server and/or the mobile device. This score may be calculated using the strength of preference for the user, the complimentary products in the user's cart, awards and/or overall ratings of the product, the effectiveness of the content (that is, the rate at which the content causes that user or users generally to put the item in their cart), and other criteria. The score may then be used by the product packaging to determine what content to display.

While various embodiments of the present invention have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be implemented to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Furthermore, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

That which is claimed:

1. A system for displaying content on product packaging comprising a product package, where the product package comprises a display board, a wireless communications interface, and a power transfer adapter; and
a mobile device, where the mobile device comprises a wireless communications interface,
where the mobile device and the product package communicate via their respective wireless communications interfaces, and where the display board of the product package displays content indicated by data provided by the mobile device through the wireless communications interfaces.

2. The system of claim 1, wherein the mobile device further comprises a processor executing programming logic for interfacing with the product package; the programming logic configured to:
receive identity data from the product package;
determine whether there is valid content available for the product package; and
send an update display request to the product package, where the update display request comprises data indicating the content to display on the display board of the product package.

3. The system of claim 2, wherein the data indicating the content to display on the display board of the product package comprises graphic data, text data, or both.

4. The system of claim 2, wherein the programming logic is further configured to request the identity data of the product package.

5. The system of claim 1, wherein the display board of the product package comprises a liquid crystal display.

6. The system of claim 1, wherein the power transfer adapter is a wireless power transfer adapter, where the wireless power transfer adapter comprises coiled wires that generate electrical current from incident magnetic fields.

7. The system of claim 1, further comprising a remote server system, where the remote server system comprises a processor executing programming logic for interfacing with the mobile device; the programming logic configured to
receive a product data request from the mobile device, where the product data request comprises a product identifier;
obtain product data using the product identifier;
determine appropriate content to display on the product package; and
send response data to the mobile phone, where the response data comprises data indicating the content to be displayed on the product package,
where the remote server system and mobile device communicate over a wide area network.

8. The system of claim 7, wherein the data indicating the content to be displayed on the product package of the response data comprises graphic data, text data, or both.

9. A method for displaying content on product packaging comprising the steps of:
receiving identity data from a product package;
sending the identity data to a remote server system;
receiving response data from the remote server system; and
sending content data to the product package;
where the product package comprises a display board, whereby the content data sent to the product package is used to display content on the display board of the product package.

10. The method of claim 9, further comprising the step of requesting the identity data of the product package prior to receiving identity data from the product package.

11. The method of claim 9, further comprising the step of determining if valid content is available for the product package.

12. The method of claim 9, where the product package further comprises electronic memory, wherein the content data comprises a reference to content previously stored in the electronic memory of the product package.

13. The method of claim 9, further comprising the step of sending user data to the remote server.

14. The method of claim 13, wherein the user data comprises data indicating products in a corresponding user's shopping cart.

15. The method of claim 13, wherein the user data comprises data indicating a user's preferences.

16. The method of claim 9, wherein the response data from the server system comprises a value of matching criteria.

17. A method for displaying content on a product package, where the product package comprises a display board and a wireless communications interface, the method comprising the steps of:
sending identity data to a mobile device;
receiving a display update request from the mobile device;
determining which content to use for the display board using the display update request received from the mobile device; and
displaying the content on the display board.

18. The method of claim 17, wherein the product package further comprises electronic memory, where the electronic memory stores a plurality of display elements, wherein the display update request received from the mobile device comprises a reference to one of the plurality of display elements stored in the electronic memory.

19. The method of claim 17, further comprising the steps of:
storing a plurality of display update requests; and
waiting a period of time;
wherein the step of determining which content to use for the display board using the display update request received from the mobile device comprises selecting one of the plurality of display update requests.

20. The method of claim 19, wherein the step of selecting one of the plurality of display update requests uses a value of matching criteria.
